(19) United States
(12) Patent Application Publication
(10) Pub. No.: US 2023/0213751 A1
(43) Pub. Date: Jul. 6, 2023

(54) ELECTROWETTING DISPLAY

(71) Applicant: MIORTECH HOLDING B.V., Eindhoven (NL)

(72) Inventors: Johannes Marra, Eindhoven (NL); Hermanus FEIL, Eindhoven (NL); Pieter Johan van der Valk, Eindhoven (NL); Rajan van Aar, Eindhoven (NL); Doeke Jolt Oostra, Eindhoven (NL)

(21) Appl. No.: 17/928,881

(22) PCT Filed: Jun. 2, 2021
(86) PCT No.: PCT/NL2021/050350

§ 371 Date: Nov. 30, 2022

(30) Foreign Application Priority Data
Jun. 2, 2020 (NL) 2025729

(51) Int. Cl. G02B 26/00

(52) U.S. Cl. CPC G02B 26/005

(57) ABSTRACT

An electrowetting optical element for enabling powering of a first and a second electrode layer for rearranging a polar liquid relative to a non-polar liquid on a hydrophobic surface of an insulating layer. The electrowetting optical element includes a first electrode layer stack, a second electrode layer stack, one or more cell walls extending between the first and second electrode stacks, and a formed containment space containing a polar liquid and a non-polar liquid wherein the liquids are immiscible with each other. Each of the one or more cell walls are mounted on a second interface surface of the second electrode layer stack and extend towards the first electrode layer.

The present invention relates, in general, to an electrowetting optical element and in particular to an electrowetting optical element arranged for enabling powering of a first and a second electrode layer for rearranging a polar liquid relative to a non-polar liquid, said electrowetting optical element comprising: a first electrode layer stack comprising a substrate, said first electrode layer, and an insulating layer having a hydrophobic first interface surface; a second electrode layer stack comprising a superstrate, and said second electrode layer having a second interface surface having a lower hydrophobicity than said first interface surface; one or more cell walls extending between said first and second electrode stack; a containment space formed between said first interface surface of said first electrode layer stack, said second interface surface of said second electrode layer stack and said one or more cell walls defining sides of said containment space, and said containment space at least containing a polar liquid and a non-polar liquid, wherein said polar and said non-polar liquids are immiscible with each other.

The present invention further relates to a method of manufacturing such an electrowetting optical element.

Electrowetting technology is based on the modification of the effective wetting preference of a hydrophobic surface of an insulating layer for a non-polar liquid relative to that for a polar liquid by means of altering the strength of an applied electric field across the insulating layer. The insulating layer, the polar liquid and the non-polar liquid are thereby part of a capacitor assembly which also comprises electrodes between which a voltage can be applied for establishing the electric field across the insulating layer.

An electrowetting optical element, further referred to as electrowetting element, according to the state of the art may, from bottom to top, be comprised of respectively a first electrode layer stack comprising a substrate, a first electrode layer, an electrically insulating hydrophobic layer or an insulating layer having a hydrophobic surface facing away from the first electrode layer for interfacing to a polar liquid and a non-polar liquid immiscible with each other comprised in a containment space, a second electrode layer stack comprising a second electrode layer and a superstrate, the second electrode layer interfacing with at least a polar liquid in the containment space. From a viewing path, the first electrode stack, at the bottom of the element can be denoted as the first stack comprising the first electrode layer. The second electrode stack at the top of the element can be denoted as the second stack and comprising the second electrode layer. The containment space comprising a polar liquid and a non-polar liquid separates the first stack from the second stack.

An electrowetting element may thus from bottom to top be comprised of respectively a first electrode layer, an electrically insulating hydrophobic layer (i.e. having a hydrophobic surface on a side opposite the side adjacent or nearest to the first electrode layer), a mixture of two liquids comprising at least a polar liquid and a non-polar liquid, and a second electrode in contact with at least the polar liquid. In practice, the liquids are contained in a containment space formed between, for example, cell walls, a hydrophobic surface of an insulating layer and an electrode on a superstrate glass plate.

Such electrowetting elements are known, for example from U.S. Pat. No. 9,274,331 B2 of the same applicant of the present disclosure. The electrowetting element disclosed therein is arranged for enabling powering of a first and a second electrode layer for rearranging a polar liquid relative to a non-polar liquid and comprises a first and second electrode layer stack and cell walls. The first electrode layer stack, which is located at the bottom of the element as seen from the viewing path comprises a substrate, a first electrode layer, and an insulating layer with a hydrophobic first interface surface. The second electrode layer stack, which is located at the top of the element, comprises a superstrate, and a second electrode layer with a second interface surface having a lower hydrophobicity then the first interface surface. The cell walls are located and extend between the first and the second stack. The space between the first interface surface and the second interface surface comprises the cell walls and the containment space. The containment space comprises the polar liquid and the non-polar liquid, which are immiscible with each other.

The cell walls of the element known from U.S. Pat. No. 9,274,331 B2 are fixedly mounted on the second interface surface of the second electrode layer stack and extend towards said first electrode layer but are not fixedly mounted to the first interface surface of the first electrode layer stack. The top of the cell walls, i.e. at their free non-fixed end, comprise a hydrophobic surface.

With this hydrophobic end face of the cell walls, the non-polar liquid is attracted by both the hydrophobic end face surface of the cell wall and the hydrophobic first interface surface in both the non-powered state and the powered-up state of the electrowetting cell. This enables the non-polar liquid to be entrained more easily in the slit between the end face surface of the cell wall and the first interface surface. As such, the polar liquid is effectively trapped inside the containment space and is prevented from spreading from one cell to another.

Forming a hydrophobic surface on the top or free end of the cell walls does in general prevent or reduce transport of polar liquid from one cell to another. The manufacturing process to make such a top hydrophobic typically contains an anneal step. The anneal step reduces the hydrophilic properties of the sides of the cell walls. As a result, the non-polar liquid may stick to the sides of the cell walls which prevents backflow or reduces the speed of backflow of the non-polar liquid from the sides of the cell walls to and across the first interface surface when the electrowetting cell switches from a powered-up modus, wherein a voltage is applied between the first and second electrode layer, to a disabled powering modus, wherein the voltage between the first and second electrode layer is removed, thereby inducing an unreliable electrowetting effect.

The present invention has for its object to obviate the above-mentioned problems and disadvantages of the prior art, and more in particular, to provide such an electrowetting optical element having an improved and more reliable electrowetting effect.

The present invention further has for its object to provide a method of manufacturing an electrowetting optical element.

In accordance with a first aspect of the present disclosure the above-mentioned object is achieved by an electrowetting optical element arranged for enabling powering of a first and a second electrode layer for rearranging a polar liquid relative to a non-polar liquid on a hydrophobic surface of an insulating layer. The electrowetting optical element comprises:

a first electrode layer stack comprising a substrate, said first electrode layer, and said insulating layer having said hydrophobic first interface surface;

a second electrode layer stack comprising a superstrate, and said second electrode layer having a second interface surface having a lower hydrophobicity then said first interface surface;

one or more cell walls extending between said first and second electrode stack;

a containment space formed between said first interface surface of said first electrode layer stack, said second interface surface of said second electrode layer stack and said one or more cell walls defining sides of said containment space, and said containment space at least containing a polar liquid and a non-polar liquid, wherein said polar and said non-polar liquids are immiscible with each other, wherein each of said one or more cell walls being fixedly mounted on said second interface surface of said second electrode layer stack and extending towards said first electrode layer.

The one or more cell walls of the proposed electrowetting element have an end face which faces the first electrode layer stack and comprise a hydrophilic surface interface with the polar and non-polar liquids in the containment space.

The principles of operation of an electrowetting element are as follows. In the unpowered state or disabled powering modus of the first and second electrode, i.e. when no voltage is applied between the first and second electrode, the system is in its lowest energetic state when the non-polar liquid forms a boundary layer between the polar liquid and the hydrophobic surface of the insulating layer. This is because of the preferential wetting of the hydrophobic surface by the non-polar liquid which effectively repels the polar liquid from contact with the hydrophobic surface. Provided that the non-polar liquid is an optically absorbing liquid across at least part of the visible wavelength region, the optical absorption of the non-polar liquid then forms an obstruction to incident light that penetrates the system, thereby creating an electrowetting element that has a reduced optical transmission across at least part of the visible wavelength region. When a voltage is applied between the first and second electrode, an electric field is set up between the first electrode and the conducting polar liquid across the combined thickness of the insulating layer and the non-polar liquid, and the lowest energetic state of the system becomes the situation wherein the (poorly conductive or insulating) non-polar liquid has at least partly been pushed aside by the (conductive) polar liquid through the force of the applied electric field. Effectively, the application of a voltage between the electrodes reduces the preferential wetting of the hydrophobic surface by the non-polar liquid. Provided that the applied voltage is large enough, the hydrophobic surface becomes preferentially wetted by the polar liquid thereby largely displacing the non-polar liquid from the hydrophobic surface. Inside the electrowetting cell, the shape of the displaced non-polar liquid is thereby transformed from a lens-shaped liquid film into a contracted droplet. In this situation, provided that the polar liquid is a substantially optically non-absorbing liquid across the visible wavelength region, incident light that penetrates the system suffers less from optical absorption by the non-polar liquid, thereby enhancing the optical transmission of incident light by the electrowetting element.

Upon switching the electrodes from the powered state back to the unpowered state, by taking away the voltage that is applied between the electrodes, the electric field across the insulating layer is nullified and the system turns back to the lowest energetic state of the system that was present before the electrodes were powered wherein the hydrophobic layer is preferentially wetted by the non-polar liquid in the shape of a non-polar liquid film, thereby displacing the polar liquid from the hydrophobic surface of the insulating layer.

In both the powered and unpowered state of the system, the liquids are kept in place, i.e. in the cells, mainly by the cell walls.

A set of cell walls creating the boundary of a single cell form, together with the first and second stacks, the enclosure of a single containment space and are in the present disclosure to be interpreted as the smallest individual element in which a polar and a non-polar liquid exhibit an electrowetting effect. At least one cell but preferably multiple cells together form an individual pixel. A pixel is considered the smallest addressable element of a display and thus, in the present disclosure, a pixel element comprises at least one electrowetting cell. A pixel may contain one or an arbitrary number of cells, for example an even number of cells or an odd number of cells.

The cell walls are formed on the second electrode stack, also known as the superstrate, and are also disclosed in the electrowetting element known from earlier generation elements available through the same applicant and mentioned in the background section of the present disclosure. The height of the cell walls is such that they extend from the second electrode layer stack at least sufficiently far towards the first electrode layer stack in order to prevent spreading and escape of the polar liquid from cell to cell.

In the known electrowetting elements, the top of the extending cell walls is made hydrophobic using a manufacturing process involving the coating of the top of the cell walls with a hydrophobic material followed by an anneal step. This anneal step, however, decreases the hydrophilicity of the cell wall side surfaces which promotes their wetting with the non-polar liquid and the adherence of the non-polar liquid to the cell wall side surfaces at the expense of their wetting with the polar liquid. As a result, in a disabled power modus, the coverage of the hydrophobic surface of the insulating layer with non-polar liquid becomes compromised to the extent that an incomplete coverage may occur and/or that backflow of the non-polar liquid across the hydrophobic surface of the insulating layer is slower.

In order to solve this, the anneal step may be optimized or replaced by an alternative process step. This, however, may introduce other disadvantages or not be as effective. As another alternative, the hydrophilicity of the sidewalls may also be restored after the anneal step, by one or more additional steps in the manufacturing process. Such steps however may also have other disadvantages and having additional steps will further increase complexity, time and costs of such manufacturing.

The inventors had the insight that, in order to obviate the above-mentioned drawbacks, the top of the extending cell walls is to be made hydrophilic instead. With such cell walls, the electrowetting effect of the electrowetting element is improved and more robust under a broader range of environmental conditions. With such hydrophilic cell wall tops, the anneal step which was needed to create the hydrophobic cell wall tops in known electrowetting elements is obviated. As a result, the effect of the decrease of the hydrophilicity of the cell wall side surfaces is obviated. As such, an electrowetting element is obtained with an improved and more reliable electrowetting effect.

In an example, said one or more cell walls are being fixedly mounted on said second interface surface and extending with a free end towards said first electrode layer, and wherein said one or more cell walls have a height which at least extends beyond the maximum distance between the second interface surface and the interface between said polar and non-polar liquid in a disabled powering modus of said first and second electrode layer.

Obviating from the hydrophobic top of the cell walls as known from the prior art and having hydrophilic top surfaces instead may increase the likelihood that polar liquid will migrate from one cell to another. However, according to the example, with cell walls having such a height, meaning that they extend substantially along the distance between the first and second stacks, and more in particular along the distance between the first and the second interface surface, the likelihood that the polar liquid would migrate from one cell to another is effectively nullified. If polar liquid would migrate to an adjacent cell, the ratio between the quantity of polar and non-polar liquid within one cell would change as well, which, in turn, increases the risk of flow of non-polar liquid to adjacent cells resulting in a non-uniform distribution of the non-polar liquid across the cells constituting a single pixel and/or across different pixels. When the non-polar liquid is a colored liquid, a non-uniform distribution of the non-polar liquid across a pixel area or across the area of the pixel assembly forming the display results in a non-uniform color across the pixel area and/or across the entire display area.

In an example, a height of said one or more cell walls extending from said second interface surface corresponds with the distance between said first and second interface surfaces.

Further increasing the height of the cell walls, i.e. further extending the walls towards the first interface surface, will prevent or at least further decrease the risk of polar liquid to migrate from one cell to another.

In an example, said end face of each of said one or more cell walls forming a top surface of a cell wall contacts said first interface surface in a loose manner.

In an example, said end face of each of said one or more cell walls forming a top surface of a cell wall contacts said first interface surface, thereby forming a sealing contact between said top surface of said cell wall and said first interface surface for sealing said polar and said non-polar liquids within said containment space.

In the preferred example, the cell walls are attached to and form an integral part of the second interface layer whereas the opposite end of the wall, facing towards the first interface layer or surface, has a free end which abuts the first interface surface. This abutting is preferably achieved in a sealing manner wherein a sealing contact is formed between said top surface of said cell wall and said first interface surface such that the polar and non-polar liquids are contained in the containment space.

In an example, said one or more cell walls comprise a compressible compound, and in particular, wherein at least a top part of said cell walls comprise said compressible compound.

Achieving a sealing contact is challenging under a broad range of environmental conditions. In non-simulated real-world conditions, low or high temperatures may affect the sealing. By manufacturing the cell walls partly or fully from a compressible compound, the sealing is improved since the cell walls may be slightly over-dimensioned. Upon closing or sandwiching the second stack with the cell walls attached to it, to the first stack, the cell walls may compress slightly in order to function as a gasket. Small imperfections in the mating surfaces of the top of the cell wall and the first interface surface are thereby allowed. The compression of the cell wall can fill or compensate these irregularities.

In an example, said one or more cell walls comprise an expandable compound, and in particular, wherein at least a top part of said cell walls comprise said expandable compound.

As an alternative to the compression, the cell walls, either fully or partly, e.g. only the top of the cell wall, may be arranged for expansion. The skilled person will appreciate which materials or compound are suitable.

In a further example, said expanding of said expandable compound, or said compressing of said compressible compound is achieved by said one or more cell walls or in particular by at least a top part of said cell walls comprising a porous structure.

In another example, said expanding of said expandable compound is achieved by said one or more cell walls or in particular at least by a top part of said cell walls being arranged for imbibition. Imbibition involves the preferential absorption of liquid through solvation of chemical moieties comprised in the cell walls.

The expanding effect of (part of) the cell wall is preferably achieved by having a porous structure or at least such a structure which is arranged to imbibe a liquid and under such effect of imbibition exhibit a growth in volume. This enables and assures highly improved sealing of the containment space by the cell walls in the presence of the imbibed liquid.

In yet another example, said porous structure comprises pores arranged for absorbing liquid when said one or more cell walls or in particular at least a top part of said cell walls are immersed in said liquid.

Preferably, the cell walls are configured to have a height which is slightly smaller than the height between the first and second interface surface. Then, the cell walls, or at least the top thereof may be immersed in a liquid which is selected to exhibit an imbibition effect on the (top of) the cell walls.

In an example, said liquid for immersing said one or more cell walls or in particular at least a top part of said cell walls comprise said polar liquid.

In an example, said immersing comprises immersing at a defined elevated temperature for a predetermined time period.

In an example, side walls of each of said one or more cell walls comprise a hydrophilic surface.

In an example, both side walls and end face of each of said one or more cell walls comprise a hydrophilic surface.

In an example, said hydrophilic surface of said side walls and end face are formed from a continuous layer.

In a second aspect, there is provided, a method of manufacturing an electrowetting optical element arranged for enabling powering of a first and a second electrode layer for rearranging a polar liquid relative to a non-polar liquid. The method comprises the steps of:

providing a second electrode layer stack comprising a superstrate and said second electrode layer having a second interface surface having a lower hydrophobicity then said first interface surface;

fixedly mounting cell walls on said second interface surface of said second electrode layer stack, thereby forming a containment space defined by said second interface surface and said cell walls, wherein an end face of each of said one or more cell walls facing said first electrode layer stack comprise a hydrophilic surface;

filling said containment space with a polar liquid and a non-polar liquid, which polar liquid and non-polar liquid are immiscible with each other; and

covering said containment space with a first electrode layer stack comprising a substrate, said first electrode layer and an insulating layer having a hydrophobic first interface surface, wherein the hydrophobicity of said hydrophobic interface surface is higher than the hydrophobicity of the second interface surface.

In a further example, said step of mounting said cell walls further comprises:

fixedly mounting said cell walls with a height of said one or more cell walls extending with a free end towards said first electrode layer, and wherein said one or more cell walls have a height which at least extends beyond the maximum distance between the second interface surface and the interface between said polar and non-polar liquid in a disabled powering modus of said first and second electrode layer, said step of covering said containment space further comprises:

covering said containment space with said first electrode layer stack such that said end face of each of said one or more cell walls contacts said first interface surface forming a sealing contact between said top surface of said cell wall and said first interface surface for sealing said polar and said non-polar liquids within said containment space.

Each of the examples described in relation to the first aspect of the invention is also applicable in relation to the second or other aspects of the invention. Correspondingly, all advantages of the first aspect and further examples thereof also apply to the second or other aspect and its examples or examples of the first aspect.

The invention will further be described with reference to the enclosed drawings wherein embodiments of the invention are illustrated, and wherein:

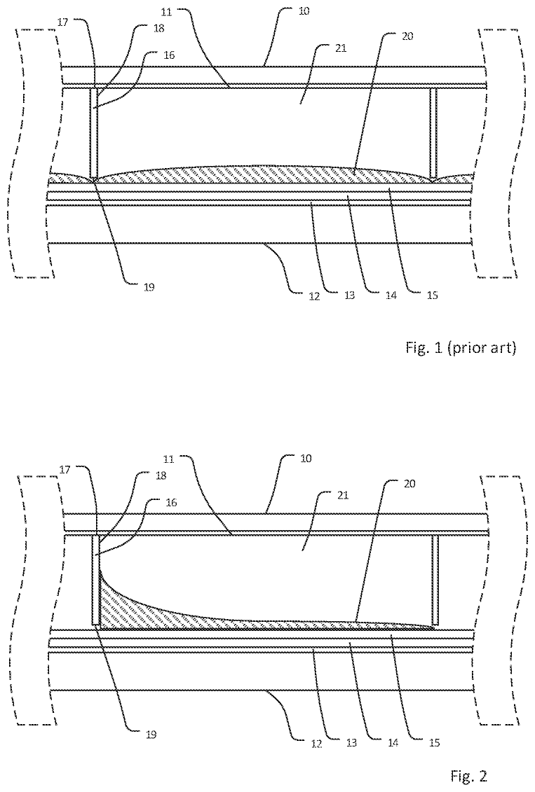

FIG. 1 shows in an illustrative manner, an electrowetting element according to the prior-art;

FIG. 2 shows in an illustrative manner, an unreliable effect of an electrowetting element according to the prior-art;

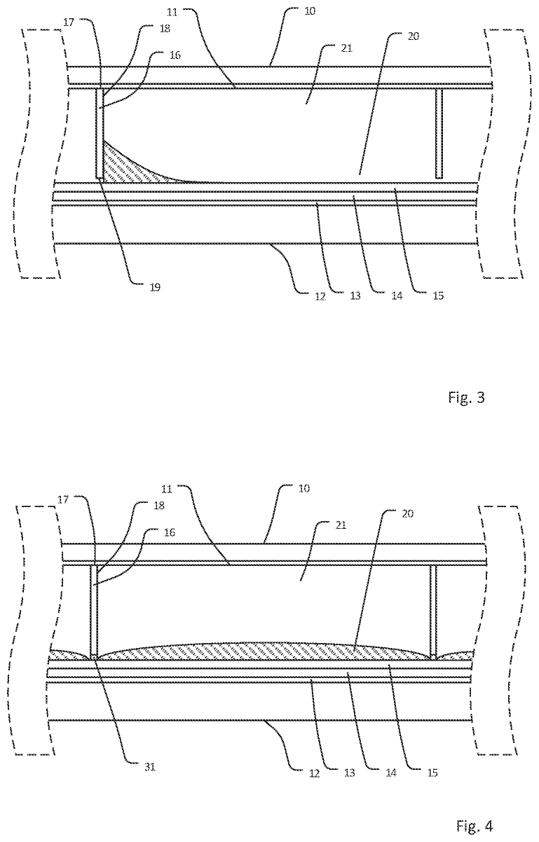

FIG. 3 shows in an illustrative manner, another unreliable effect of an electrowetting element according to the prior-art;

FIG. 4 shows in an illustrative manner, an electrowetting element according to a first aspect of the invention.

FIG. 1 shows an electrowetting optical element or further referred to as electrowetting element, according to the state of the art. The element consists of two electrode layer stacks, one at the bottom and one at the top. The stack at the bottom, as seen from a viewing path, being the first electrode layer stack, and consists of respectively a substrate 12, a first electrode layer 13, an electrically insulating hydrophobic layer 14 or an insulating layer 14 having a hydrophobic surface 15. The hydrophobic surface 15 interfaces with at least a non-polar liquid 20 capable of displacing a polar liquid 21 from the hydrophobic surface 15 through its preferential wetting of the hydrophobic surface 15. These liquids are immiscible with each other and contained in a containment space. The containment space defines one cell and is formed by the first stack at the bottom, the second stack at the top, and a set of cell walls 16 which are disposed in parallel at a certain distance from each other.

The second electrode layer 11 of the superstrate 10 and the first electrode layer 13 of the substrate 12 could be formed to only apply a voltage across one single cell, but are preferably, as also shown in FIG. 1, continued for multiple cells. In this way, multiple cells together may form one single pixel element which is independently addressable.

The element in FIG. 1 further comprises a second electrode layer stack which consists of a second electrode layer 11 and a superstrate 10. The second electrode layer 11 interfaces with at least a polar liquid 21 in the containment space. As indicated, seen from a viewing path, the first electrode stack, at the bottom of the element can be denoted as the first stack comprising the first electrode layer. The second electrode stack at the top of the element can be denoted as the second stack and comprising the second electrode layer. The containment space comprising a polar liquid and a non-polar liquid separates the first stack from the second stack.

In order to define the cells and to keep the liquids inside their cells in the containment space, the element contains cell walls 16. As known, these cell walls are fixedly mounted at one end 17 to the second interface surface 11 of the second electrode layer stack. The opposite end 19 of the cell walls is not fixedly mounted at that end to the first interface surface 15 of the first electrode layer stack, but rather has a free and thus non-fixed end 19. This free end comprises a hydrophobic top 19. The non-polar liquid 20 is attracted to both the hydrophobic end face surface 19 of the cell wall 16 and to the hydrophobic first interface surface 15 in both the non-powered and the powered-up state of the electrowetting cell. This enables the non-polar liquid 20 to be entrained more easily into the slit between the end face 19 and the first interface surface 15. As such, the polar liquid 21 is trapped inside the containment space and is prevented from spreading from one cell to another. In order to obtain such a hydrophobic surface on the top or free end 19 of the cell walls 16, both a coating step with a hydrophobic material and a subsequent anneal step is required.

With this anneal step, the hydrophilic properties of the sides 18 of the cell walls 16 are reduced. As a result, the non-polar liquid 20 may stick to the sides 18 of the cell walls 16 which prevents backflow or reduces the speed of backflow of the non-polar liquid 20 from the sides 18 of the cell walls 16 to and across the first interface surface 15 when the electrowetting element is switched from a powered-up modus back to a disabled powering modus of the first and second electrode layer, thereby inducing an unreliable electrowetting effect. This effect is clearly shown in FIG. 2 in which the element is in a disabled powering modus and wherein thus no voltage is applied between the first and second electrodes 11, 13. The non-polar liquid 20 should preferably be distributed evenly as a lens-shaped liquid film across the first interface surface 15 in the cell as illustrated in the non-powered modus of the electrowetting element shown in FIG. 1 in order to be most effective as an optically absorbing liquid film when the non-polar liquid 20 is optically absorbing across at least part of the visible wavelength region. In FIG. 2 however, it can be seen, that the non-polar liquid 20 of the prior-art element also shown in FIG. 1 climbs up a side of the cell wall 16 because of the cell wall's annealing-induced increased hydrophobicity which promotes its wetting with the non-polar liquid 20. The resulting uneven distribution of the non-polar liquid 20 across the cell in FIG. 2 induces an unreliable and non-reproducible electrowetting effect. Because part of the non-polar liquid 20 in the cell has climbed the side 18 of the cell wall 16, the resulting non-uniform coverage of the hydrophobic interface surface 15 with optically-absorbing non-polar liquid 20 leads to an undesired increased optical transmission of incident light through the cell.

In FIG. 3, another more extreme example is shown of an unreliable electrowetting effect in the disabling power modus. Here, most of the non-polar liquid 20 adheres to the side of the cell wall 16, thereby effectively depleting the hydrophobic interface surface 15 from most of the non-polar liquid 20. This leads to an undesirable almost unhindered transmission of incident light through the cell when the non-polar liquid 20 is optically absorbing across at least part of the visible wavelength region.

In FIG. 4 an electrowetting optical element according to an aspect of the disclosure is shown. It is arranged for enabling powering of a first 13 and a second electrode layer 11 for rearranging a polar liquid 21 relative to a non-polar liquid 20 on a hydrophobic surface 15 of an insulating layer 14. The electrowetting optical element comprises a first electrode layer stack with a substrate 12, the first electrode layer 13, and the insulating layer 14 having said hydrophobic first interface surface 15. The substrate 12 may be made from glass or another substrate material which is transparent across the visible light spectrum. The interface surface or interface layer thus covers the electrode layer 13, which is transparent. The interface layer 15 or at least its surface is preferably a made from a fluoropolymer. To improve the adhesion of the fluoropolymer 15 to the insulator layer 14, the substrate 12 may preferably also be provided with an adhesion promoting layer which is disposed between the fluoropolymer 15 and the insulator layer 14.

The electrowetting optical element further comprises a second electrode layer stack comprising a superstrate 10, and the second electrode layer 11 which has a second interface surface having a lower hydrophobicity then the first interface surface. Similar to the first substrate 12, the second substrate 10 or also known as the superstrate 10 may also be constructed from glass. On top of the glass superstrate, from a viewing path, the second electrode layer 11 is formed as a transparent electrode, formed from electrically conductive material such as indium tin oxide. However, also conductive organic materials known in the art may be used which possess a suitable lower hydrophobicity than the hydrophobic interface surface 15 of the first stack.

The element also contains one or more cell walls, in which a set or multiple cell walls define a cell, depending on the form of the cells. These could be cubic, but also hexagonal shaped or any other suitable shape. The cell walls 16 extend between the first and second electrode stack. Between the cell walls and the first and second stack a containment space is formed. The containment space at least contains polar liquid 21 and non-polar liquid 20 which are immiscible with each other.

The containment space is thus provided with a polar liquid 21. Every suitable polar liquid may be applied, however, being readily available and at low-cost, water, glycols, glycerine or mixtures thereof may be used as the polar liquid of the present embodiment of the invention. In addition to the polar liquid, the cell or containment space further comprises a non-polar liquid 20. The polar liquid and non-polar liquid are immiscible forming a polar-non-polar liquid interface. The oil used as non-polar liquid 20 may be decane or another suitable liquid, such as selected from a group comprising mineral oils, animal and vegetable oils, high-boiling hydrocarbons, higher fatty acids, silicone liquids, in particular alkanes such as octane, decane, dodecane, vaseline, spindle oil, castor oil, olive oil and liquid paraffin.

As shown in FIG. 4, each of the cell walls is fixedly mounted on the second interface surface 11 of said second electrode layer stack and is directed with its other end 19 towards the first electrode layer. The end face 19 of each of the one or more cell walls facing the first electrode layer stack comprises a hydrophilic surface. This surface may be formed as a skin on the cell walls 16, and may or may not be continuous with the sides 18 of the cell walls 16. The surface may however also be continuous over the whole volume of the cell wall 16, which defines a monolithic cell wall with hydrophilic properties and thus a hydrophilic surface on the top 19 and sides 18 of the cell walls 16.

The top 19 or free end of the cell walls 16, which is at least free and non-fixed before the final assembly of the element, is hydrophilic. Due to these hydrophilic properties, the polar liquid 21 may have a tendency to diffuse from one cell to another and, as a result, the non-polar liquid 21 will also have a tendency to migrate to other cells. Consequently, the volume ratio between the polar and non-polar liquid in individual cells becomes affected and a non-uniform distribution of non-polar liquid will result in an unreliable electrowetting effect. Therefore, to avoid an unreliable electrowetting effect, the free end 19 of the cell wall should preferably form a sealing contact with the interface surface 15 of the first stack.

In order to achieve a reliable seal between the top 19 of the cell wall 16 and the interface surface 15 of the first stack, a part of the cell wall 16, preferably a top section 19 (but this may also be a thin layer formed as a skin on the top and/or on the side walls 18 or part of the side wall 18 near the top 19 thereof) is made from a material which can expand under particular circumstances. Preferably, the expandable material is a material which is arranged for imbibition. Imbibition is the ability of the material to absorb a fluid through solvation which results in a swelling of the material. The swelling will assure an effective seal between the top 19 of the cell wall 16 and the interface surface 15. The degree of swelling and thus expanding can be selected or defined by one or a combination of the amount of material with imbibition ability in the cell wall, or by the location thereof. For example, the cell wall may be formed from a material with imbibition ability combined with another material lacking the ability to imbibe, wherein the ratio between both materials defines the net degree of imbibition. More preferably however, the material with imbibition ability may be located solely at the top part 19 of the cell wall 16, e.g. at the top 1, 2, 5, 10, 15, 20, 25 or 30% of the height of the cell wall 16. The degree of swelling and thus expanding may however also be defined by the duration of soaking of the cell walls 16 or the tops 19 thereof in a liquid. The imbibed liquid is preferably the polar liquid 21 which is also present in the containment space. The soaking is preferably done at an elevated temperature of the liquid, which elevation not only improves the imbibition effect on the material, but also decreases the time needed to achieve a pre-defined swelling volume. As such, the swelling volume may be predefined, and for example set to achieve a swelling of approximately 1, 2, 3, 4, 5, 7 or 10% of the height of the cell wall 16.

As will be appreciated by the person skilled in the art, the present invention may be practised otherwise than as specifically described herein. Obvious modifications to the embodiments disclosed, and specific design choices, will be apparent to the skilled reader. The scope of the invention is only defined by the appended claims.

1-17. (canceled)

18. An electrowetting optical element configured for enabling powering of a first electrode layer and a second electrode layer for rearranging a polar liquid relative to a non-polar liquid on a hydrophobic first interface surface of an insulating layer, the electrowetting optical element comprising:
a first electrode layer stack comprising a substrate, the first electrode layer, and the insulating layer having the hydrophobic first interface surface;
a second electrode layer stack comprising a superstrate, and the second electrode layer having a hydrophobic second interface surface having a lower hydrophobicity than the hydrophobic first interface surface;
one or more cell walls extending between the first electrode stack and the second electrode stack; and
a containment space formed between the hydrophobic first interface surface of the first electrode layer stack and the hydrophobic second interface surface of the second electrode layer stack, and the one or more cell walls defining sides of the containment space, and the containment space containing at least a polar liquid and a non-polar liquid, wherein the polar liquid and the non-polar liquid are immiscible with each other;
wherein each of the one or more cell walls are fixedly mounted on the hydrophobic second interface surface of the second electrode layer stack and extend towards the first electrode layer; and
wherein an end face of each of the one or more cell walls, opposite and facing the first electrode layer stack, comprises a hydrophilic surface.

19. The electrowetting optical element according to claim 18, wherein the one or more cell walls are fixedly mounted on the hydrophobic second interface surface and extend with a free end thereof towards the first electrode layer, and wherein the one or more cell walls have a height that at least extends beyond a maximum distance between the hydrophobic second interface surface and the interface between the polar and the non-polar liquid in a disabled powering modus of the first electrode layer and the second electrode layer.

20. The electrowetting optical element according to claim 18, wherein a height of the one or more cell walls extending from the hydrophobic second interface surface corresponds with a distance between the hydrophobic first and second interface surfaces.

21. The electrowetting optical element according to claim 20, wherein the end face of each of the one or more cell walls forming a top surface of a cell wall loosely contacts the hydrophobic first interface surface.

22. The electrowetting optical element according to claim 18, wherein the end face of each of the one or more cell walls forming a top surface of a cell wall contacts the hydrophobic first interface surface thereby forming a sealing contact between the top surface of the cell wall and the hydrophobic first interface surface for sealing the polar and the non-polar liquids within the containment space.

23. The electrowetting optical element according to claim 18, wherein the one or more cell walls comprise a compressible compound or an expandable compound in a top part of the one or more cell walls.

24. The electrowetting optical element according to claim 23, wherein the compressible compound or the expandable compound comprises a porous structure.

25. The electrowetting optical element according to claim 24, wherein the porous structure is configured for imbibition with the polar liquid.

26. The electrowetting optical element according to claim 24, wherein the porous structure comprises pores configured to absorb liquid during an immersing process.

27. The electrowetting optical element according to claim 26, wherein the liquid is the polar liquid.

28. The electrowetting optical element according to claim 26, wherein the immersing process is performed at a predetermined elevated temperature for a predetermined time period.

29. The electrowetting optical element according to claim 18, wherein side walls of each of the one or more cell walls comprise a hydrophilic surface.

30. The electrowetting optical element according to claim 18, wherein each of side walls and an end face of each of the one or more cell walls comprise a hydrophilic surface.

31. The electrowetting optical element according to claim 30, wherein the hydrophilic surface of the side walls and the end face are formed from a continuous layer.

32. A method of manufacturing an electrowetting optical element configured for enabling powering of a first electrode layer and a second electrode layer for rearranging a polar liquid relative to a non-polar liquid, the method comprising the steps of:
providing a first electrode layer stack comprising a substrate, the first electrode layer, and an insulating layer having a hydrophobic first interface surface;
providing a second electrode layer stack comprising a superstrate and the said second electrode layer having a hydrophobic second interface surface having a lesser hydrophobicity than the hydrophobic first interface surface;
fixedly mounting cell walls on the hydrophobic second interface surface of the second electrode layer stack thereby forming a containment space defined by the hydrophobic second interface surface and the cell walls, wherein an end face of each of the cell walls facing the first electrode layer stack comprises a hydrophilic surface;
filling the containment space with a polar liquid and a non-polar liquid, wherein the polar liquid and the non-polar liquid are immiscible with each other; and
covering the containment space with the first electrode layer stack such that the hydrophobic first interface surface faces the hydrophobic second interface surface.

33. The method according to claim 32, wherein:
the step of mounting the cell walls comprises fixedly mounting the cell walls with a height of the cell walls extending with a free end towards the first electrode layer, wherein the cell walls have a height that at least extends beyond a maximum distance between the hydrophobic second interface surface and an interface between the polar liquid and the non-polar liquid in a disabled powering modus of the first electrode layer and the second electrode layer; and
the step of covering the containment space comprises covering the containment space with the first electrode layer stack such that the end face of each of the cell walls contacts the hydrophobic first interface surface thereby forming a sealing contact between the top surface of the cell walls and the hydrophobic first interface surface for sealing the polar liquid and the non-polar liquid within the containment space.
